(19) United States
(12) Patent Application Publication
(10) Pub. No.: US 2007/0288178 A1
(43) Pub. Date: Dec. 13, 2007

(54) Ultrasound Imaging Method of Extracting a Flow Signal

(75) Inventor: Odile Bonnefous, Rueil-Malmaison (FR)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(73) Assignee: KONINKLIJKE PHILIPS ELECTRONICS N.V., EINDHOVEN (NL)

(21) Appl. No.: 11/576,371

(22) PCT Filed: Oct. 6, 2005
(86) PCT No.: PCT/IB05/53285

§ 371 Date: Mar. 30, 2007

(30) Foreign Application Priority Data
Oct. 8, 2004 (EP) 04300669.1

(51) Int. Cl. G01F 1/66

(52) U.S. Cl. 702/48

(57) ABSTRACT

The present invention relates to a method of extracting a flow signal from echographic signals received from a region of interest comprising moving tissues and flowing fluids. The method comprises a step of calculating Doppler signals from said echographic signals within a small number of time samples, a step of separating first and second estimated Doppler signals from said calculated Doppler signals, a step of calculating a linear combination of said first and second estimated Doppler signals which locally maximizes a temporal coherence, a step of deriving a third and fourth estimated Doppler signals from first and second maxima of said temporal coherence, a step of classifying said third and fourth estimated Doppler signals into an estimated Doppler clutter and flow components. The method finally comprises a step of forming a motion image of the flowing fluids from said estimated Doppler flow component.

### FIELD OF THE INVENTION

The present invention relates to an ultrasound imaging method of extracting a flow signal from echographic signals received from a region of interest comprising moving tissues and flowing fluids. The present invention also concerns an ultrasound imaging system which is operated to use such a method.

The present invention finds in particular its application in the domain of medical ultrasound imaging where the moving tissues are typically arterial or cardiac walls and the flowing fluids are blood flows.

### BACKGROUND OF THE INVENTION

When transmitting a beam of ultrasound signals to a region of interest of the human body comprising moving tissues and/or flowing fluids, echographic signals are received, which comprise both a clutter component and a flow component. Prior art techniques have been developed for removing the clutter component and extracting some characteristics of the flow component.

In the international patent application published under number IB2003/004899, an ultrasound imaging system is disclosed, which comprises:
means for forming a set of beams of ultrasound data signals in order to receive multiline echographic signals RS within a small number EL of time samples from a region of interest comprising moving tissues and flowing fluids,
means for calculating Doppler signals X from said received echographic signals within said small number EL of time samples, said Doppler signals X comprising a Doppler clutter component corresponding to said moving tissues and a Doppler flow component corresponding to said flowing fluids,
means for separating said Doppler flow component from said Doppler clutter component, said Doppler clutter and flow components being assumed to be temporally uncorrelated and spatially correlated,
means for producing and displaying images from said separated Doppler flow component.

In accordance with the prior art, the separation means comprise submeans for calculating an auto-correlation function of temporally uncorrelated and spatially correlated Doppler clutter and flow components, submeans for calculating a spatial correlation diagonal matrix from said autocorrelation function and submeans for separating the temporally uncorrelated Doppler components corresponding to the Doppler clutter and flow components from said diagonal matrix.

A Principal Component Analysis is performed, which provides two orthogonal signals. This analysis is based on the assumption that the Doppler clutter and flow components can be modelized by harmonic signals with two distinct frequencies. A problem is that when a limited number of transmissions is performed, the obtained Doppler clutter and flow components have a large spectrum comprising more than one frequency, which do overlap. Therefore, the Principal Component Analysis does not lead to a reliable separation of the Doppler clutter and flow components.

### SUMMARY OF THE INVENTION

It is therefore an object of the invention to provide a solution for reliably separating the Doppler clutter and flow components of the Doppler signals calculated within a limited number of time samples.

This is achieved by an ultrasound imaging method, comprising the steps of:
forming a set of beams of ultrasound data signals in order to receive echographic signals RS with a small number EL of time samples from a region of interest comprising moving tissues and flowing fluids,
calculating Doppler signals X from said received echographic signals within said small number EL of time samples, said Doppler signals X comprising a Doppler clutter component corresponding to said moving tissues and a Doppler flow component corresponding to said flowing fluids,
separating said Doppler signals X into an orthonormal basis of a first estimated Doppler signal Z₁ and a second estimated Doppler signal Z₂,
calculating linear combinations of said first and second estimated Doppler signals which maximize a temporal coherence of said Doppler signals over said small number EL of time samples 1, expressed by:

$$\hat{C} = \vert \frac{{\sum }_{l = 1}^{EL - 1} Z Z ( l ) Z {Z}^{*} ( l + 1 )}{\sqrt{{\sum }_{l = 1}^{EL - 1} Z Z ( l ) Z {Z}^{*} ( l ) {\sum }_{l = 2}^{EL} Z Z ( l ) Z {Z}^{*} ( l )}} \vert ,$$
deriving a third and a fourth estimated Doppler signals from first and second maxima of the coherence map,
classifying said third and a fourth estimated Doppler signals into an estimated Doppler clutter and an estimated Doppler flow components,
producing and displaying an image of the flowing fluids of said region of interest from said estimated Doppler flow component.

With the invention a PCA analysis is firstly performed, the two first eigen vectors providing an orthonormal basis comprising first and second Doppler signals. Then, a temporal autocorrelation function is calculated for all possible linear combinations of said first and second Doppler signals as a temporal coherence function and the combinations which maximize this temporal coherence function are isolated. This temporal coherence function is not normalised in the same way as the autocorrelation function of the prior art and make the coherence maximization criteria effective. The temporal coherence is expected to be maximal with a value close or equal to 1 for a single signal and to decrease for a mixture of signals. Usually, two local maxima are found, which confirm the hypothesis that two components are forming the initial Doppler signals, but it may happen that only one maximum is found, which means that no flow component is present in the signals. The first and second maxima form a non necessarily orthonormal basis, from which third and fourth estimated Doppler signals can be derived. A further step of classification is intended to associate each of the first and second maxima with the corresponding Doppler components among the Doppler flow and clutter components.

Therefore, the method in accordance with the invention is based on a maximization of the time coherence of the Doppler clutter and flow components of the calculated Doppler signals. Consequently, with the invention, a more reliable extraction of the Doppler and flow components is provided.

An advantage of the method in accordance with the invention is that only three time samples are needed for calculating the temporal coherence.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a schematical drawing of the method in accordance with the invention,

FIG. 2 is a map of all the possible linear combinations of the first and second Doppler signals as a function of two parameters θ and φ,

FIG. 3 is a schematical drawing of the classification step in accordance with an embodiment of the invention,

FIG. 4 is a schematical drawing of an ultrasound imaging system in accordance with the invention.

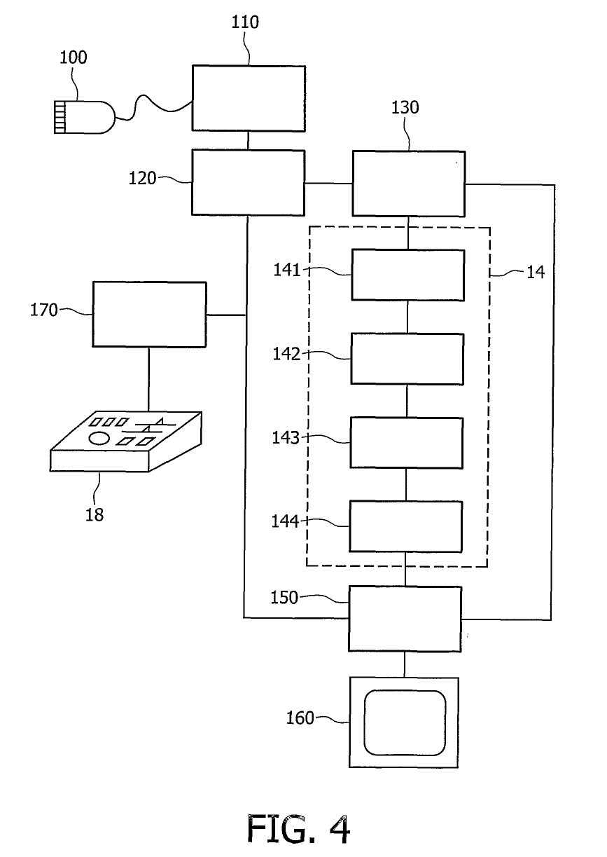

### DETAILED DESCRIPTION OF THE INVENTION

The invention relates to an ultrasound imaging method of extracting a flow component from echographic signals received from a region of interest comprising moving tissues and flowing fluids and of forming a motion image of said flow component. In the following, the particular domain of medical ultrasound imaging is considered and the moving tissues and flowing fluids are typically arterial or cardiac walls and blood flows. In this domain both the acquisition of 3D echographic data sets and the imaging of the blood flows offer a real added value for early diagnosis of arterial or cardiac diseases.

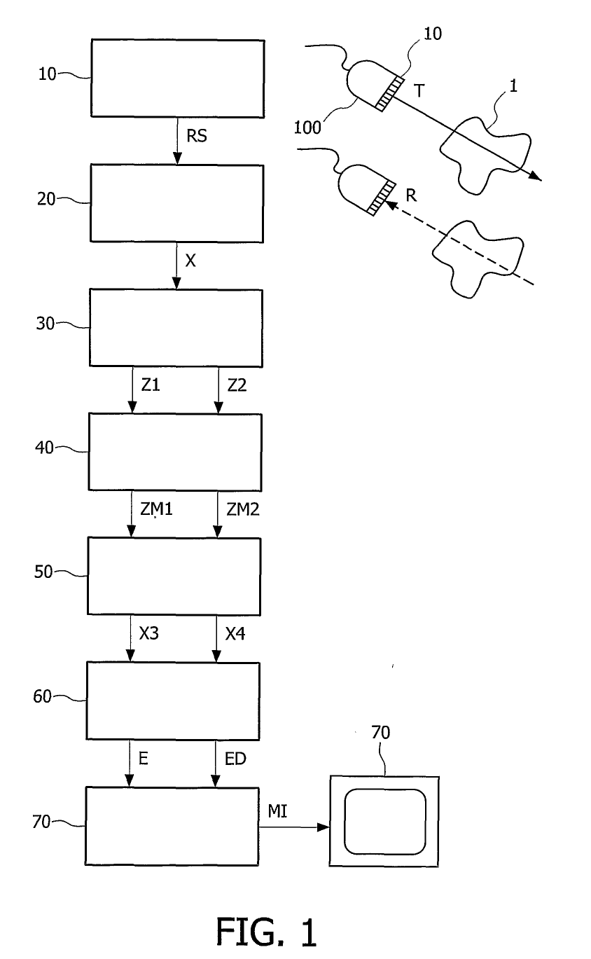

Referring to FIG. 1, the method in accordance with the invention comprises a step 10 of forming a set of beams of ultrasound data signals in order to receive echographic signals RS with a small number EL of time samples from a region of interest comprising moving objects, a step 20 of calculating Doppler signals X from said received echographic signals RS within said small number EL of time samples. The calculated Doppler signals X comprise a Doppler clutter component and a Doppler flow component corresponding to the moving tissues and the flowing fluids of the region of interest, respectively. The method in accordance with the invention further comprises a step 30 of separating the Doppler signals X into an orthonormal basis of a first Doppler signal Z₁ and a second Doppler signal Z₂. A step 40 is then intended to calculate linear combinations of said first and second Doppler signals which maximize a temporal coherence map of said Doppler signals over said small number EL of time samples 1. Such a temporal function is expressed by

$$: \hat{C} = \vert \frac{{\sum }_{l = 1}^{EL - 1} Z Z ( l ) Z {Z}^{*} ( l + 1 )}{\sqrt{{\sum }_{l = 1}^{EL - 1} Z Z ( l ) Z {Z}^{*} ( l ) {\sum }_{l = 2}^{EL} Z Z ( l ) Z {Z}^{*} ( l )}} \vert .$$

One or two maxima of the coherence map computed from the linear combinations of the two basis Doppler function are determined and the corresponding one or two Doppler signals Z_{M1} and Z_{M2} are generated. They constitute a non necessarily orthonormal basis of the Doppler signals X, from which third and fourth estimated Doppler signals X₃ and X₄ of the Doppler clutter and flow components can be derived by a step 50. A classification step 60 is intended to classify said third and fourth estimated Doppler signals X₃ and X₄ into an estimated Doppler clutter and flow components using classification criteria. A step 70 is intended to form and display a motion image representing the flowing fluids from said estimated Doppler flow component.

Advantageously, the step 30 of separating the Doppler signals X into an orthonormal basis of a first Doppler signal Z₁ and a second Doppler signal Z₂ consists in a Principal Component Analysis of the Doppler signals X, which is well-known to those skilled in the art.

The Doppler signals X can be expressed as a linear combination of a matrix of Doppler flow components and a matrix of Doppler clutter components in the following way:

X(P,T)=A_{F}(P)S_{F}(T)+A_{Cl}(P)S_{Cl}(T), where X(P,T) is a function of time and space, the Doppler flow and clutter components are only function of time and their amplification factors A_{F} and A_{Cl}, are only function of space.

With matrices such an equation becomes: X=A.S, where X is a matrix of (n, EL) elements, n being a space position number and EL the number of time samples, A a matrix of (n, 2) elements and S a matrix of (2, EL) elements. The object of the separation step 30 is therefore to find out an estimation Z of the matrix S, such that Z=WX where W is a matrix equal to A⁻¹. This is for instance achieved as described in the prior art document published under number IB2003/004899 by diagonalizing a spatial correlation matrix of the Doppler signals X(P, T). This permits of computing a spatial correlation diagonal matrix allowing the separation of the temporally uncorrelated Doppler components corresponding to flow signals and clutter signals. Such a spatial correlation diagonal matrix comprises a number EL of eigen vectors, from which a number of EL estimated Doppler signals can be derived. The two first eigen vectors are kept as a first estimated Doppler signal Z₁ and a second estimated Doppler signal Z₂, which form an orthonormal basis for forming all possible linear combinations of both estimated Doppler signals. The estimated Doppler signals Z₁ and Z₂ can be expressed as a matrix Z such that Z=W₁X.

Starting from said orthonormal basis the object of the step 40 is to search among all possible linear combinations of the estimated Doppler signals Z₁ and Z₂ for the ones which locally maximize a temporal coherence function. As a matter of fact, a linear combination corresponding to only one of the temporally uncorrelated Doppler components of the Doppler signals should have a temporal coherence equal or at least close to one, because it is not temporally mixed with another Doppler signal.

A linear combination of the estimated Doppler signals Z₁ and Z₂ can be expressed as follows: Z=cos [symbol] Z₁+sin [symbol] e^{jφ}Z₂, where θ and φ are parameters which allow to cover all the possible solutions. θ is expected to vary between 0 and π/2 and φ between −π and π.

An amplitude of the temporal coherence is calculated in the following way:

$$\hat{C} = \frac{{R}_{1}}{{R}_{0}} , \\ where {R}_{1} = {\sum }_{l = 1}^{EL - 1} Z ( l ) {Z}^{*} ( l + 1 ) and {R}_{0} = \sqrt{{\sum }_{l = 1}^{EL - 1} Z ( l ) {Z}^{*} ( l ) {\sum }_{l = 2}^{EL} Z ( l ) {Z}^{*} ( l )} ,$$

where EL is greater than or equal to 3.

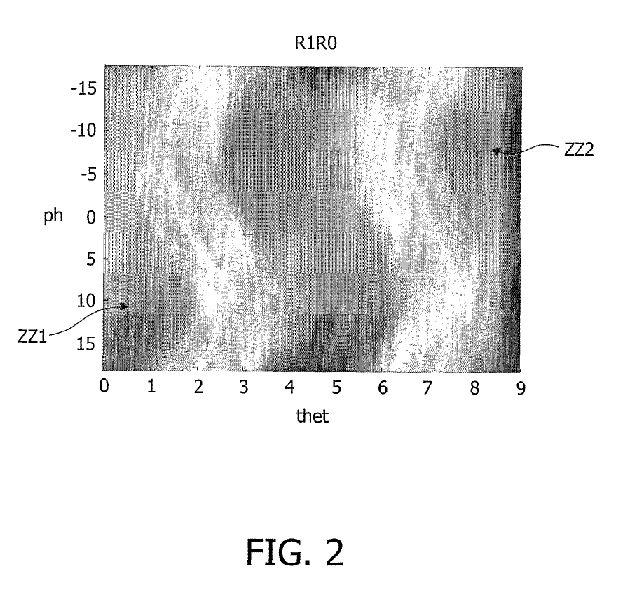

Referring to FIG. 2 a coherence map showing all the possible linear combinations of Z₁ and Z₂ as a function of θ and φ is advantageously used. A number of maxima, usually two, corresponding to the Doppler flow and clutter components, are detected on the coherence map. They are located by pairs (θ₁, φ₁) and (θ₂, φ₂).

The first maximum represents the linear combination S₁=cos [symbol] ₁Z₁+sin [symbol] ₁e^{jφ}_{₁}Z₂ and the second maximum the linear combination S₂=cos [symbol] ₂Z₁+sin [symbol] ₂e^{jφ}_{₂}Z₂.

A matrix W₂ is obtained, such that the searched Doppler flow and clutter components

$$S = [ \begin{matrix}{S}_{1} \\ {S}_{2}\end{matrix} ]$$

verify the equation: S=W₂Z and W₂ can be expressed as:

$${W}_{2} = [ \begin{matrix}cos {ϑ}_{1} & sin {ϑ}_{1} {ⅇ}^{{jϕ}_{1}} \\ cos {ϑ}_{2} & sin {ϑ}_{2} {ⅇ}^{jϕ2}\end{matrix} ]$$

Advantageously a separation measure SM is calculated in the following way:

SM=det(W₂). Such a separation measure SM indicates how much both maxima Z_{M1} and Z_{M2} are different from each other and therefore provides a reliability measure about the result obtained.

An optimized estimation of the matrix S can be derived from step 40. The matrix S, corresponding to the two Doppler components, can be expressed as follows: S=W₂Z=W₂W₁X=WX with W=W₂W₁. The amplitude matrix A is therefore obtained by inverting the matrix W: A=W⁻¹.

Consequently, a third and fourth estimated Doppler signals X₃ and X₄ are obtained, which can be expressed as:

$${X}_{3} = A [ \begin{matrix}{S}_{1} \\ 0\end{matrix} ] and {X}_{4} = A [ \begin{matrix}0 \\ {S}_{2}\end{matrix} ]$$

A problem is that we do not know which estimated Doppler signal X₃, X₄ corresponds to the Doppler flow and clutter components S₁, S₂ respectively.

Consequently, the classification step 60 is intended to classify said estimated Doppler signal into the Doppler flow and clutter components using classification criteria.

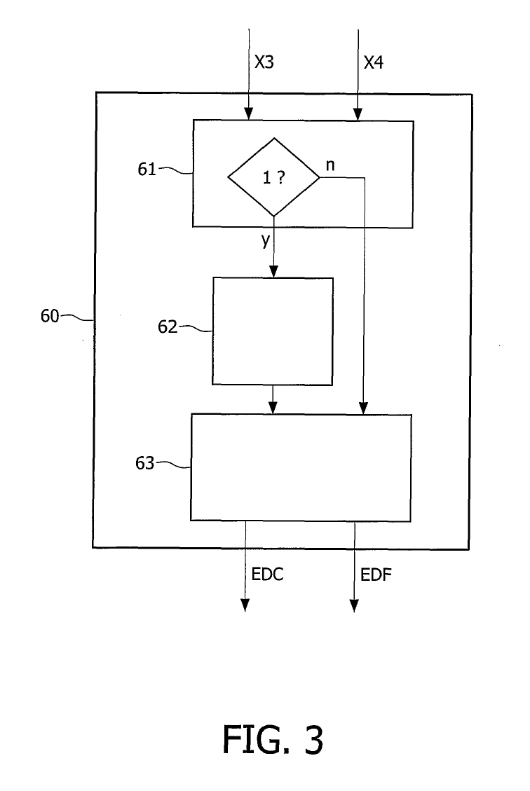

In an embodiment of the invention shown in FIG. 3, the classification step 60 comprises a decision substep 61 which is based on the following principles:
if only one maximum Z_{M1} has been found by step 40, it should mean that there is no Doppler flow component present in the Doppler signals X. Therefore, only one estimated Doppler signal X₃ is derived.
However, the classification step 60 in accordance with the invention advantageously comprises a substep 62 of checking whether there is no Doppler flow component at all. This is for instance achieved by subtracting the estimated Doppler signal X₃ to the Doppler signal X. An amplitude of the obtained difference Doppler signal X−X₃ is calculated. If such an amplitude is higher than a noise threshold level then it is finally concluded that two Doppler components are present in the Doppler signal X, which are the estimated Doppler signal X₃ corresponding to the Doppler clutter component and X−X₃ corresponding to the Doppler flow component. If not, it is decided that the Doppler signal X only comprises a Doppler clutter component and that no flowing fluid is present in the region of interest.
If two maxima X₃ and X₄ have been found in the coherence map, several classification criteria can be used to classify the maxima between the Doppler clutter and the Doppler flow components. For instance, the classification criteria comprise the amplitude of the component contribution and the velocity, but they depend on the a priori knowledge that we have about the flowing fluid and the moving tissue.
Advantageously the classification step 60 further comprises a validation substep 63 of validating the classification, which consists in checking that the classification made is compatible with a validation measure. Such a validation measure is for instance a measure which has been previously calculated, such as the separation measure SM, the relative amplitudes of the estimated Doppler signals, a decoherence D of the Doppler signals X such that D=1−Ĉ, where Ĉ is the spatiotemporal coherence of the Doppler signals X or a combination of the amplitude and the separation measure SM.

An example of classification is provided when the region of interest is a carotid. In this case, the Doppler clutter component may be weak and only one maximum is found. The checking substep calculates the difference X−X₃ between the Doppler signals X and the single maximum X₃. The amplitude is used for checking if the the difference Doppler signal is not only due to noise, but cannot be chosen as a classification criterion, because in this case the Doppler clutter component is not expected to have an amplitude greater than the one of the Doppler flow component. Preferably, in that case, the classification criterion of velocity is used. As a validation, the decoherence D of the generated Doppler signal X is calculated. Such a validation measure should validate the fact that there are two Doppler components in the Doppler signal X.

The present invention also concerns a medical ultrasound imaging system shown in FIG. 3 for imaging a region of interest comprising first and second moving objects, for instance a flowing fluid and moving tissues, and for forming a motion image of said flowing fluid. An ultrasound probe 100 comprising a 2D transducer array 101 is connected to a beamformer module 110, which controls transmission of the ultrasound signals TS and reception of the echographic signals RS by the probe. The beamformer module 110 forms received echographic signals which are coupled to a radio frequency (RF) signal processing module 120 for signal preprocessing such as amplification and bandpass filtering. The RF signals are then coupled to a Doppler module 130, which is operated to form Doppler signals X within a small number of time samples. The Doppler signals X are expected to comprise a Doppler flow component due to the flowing fluid and a Doppler clutter component due to the moving tissues of the region of interest. The Doppler signals X are then coupled to a signal processor 140, comprising sub-means 141 for separating said Doppler signals X into an orthonormal basis of a first Doppler signal Z₁ and a second Doppler signal Z₂, submeans 142 calculating linear combinations of said first and second Doppler signals which maximize a temporal coherence value Ĉ of said linear combinations of Doppler signals over said small number EL of time samples 1, expressed by:

$$\hat{C} = \vert \frac{{\sum }_{l = 1}^{EL - 1} Z Z ( l ) Z {Z}^{*} ( l + 1 )}{\sqrt{{\sum }_{l = 1}^{EL - 1} Z Z ( l ) Z {Z}^{*} ( l ) {\sum }_{l = 2}^{EL} Z Z ( l ) Z {Z}^{*} ( l )}} \vert .$$

A number of maxima, usually a first and a second maxima Z_{M1} and Z_{M2}, are obtained.

The signal processor 140 further comprises submeans 143 for deriving a third and a fourth estimated Doppler signals X₃ and X₄ from said first and second maxima and submeans 144 for classifying said Doppler signals X₃ and X₄ into an estimated Doppler clutter EDC and an estimated Doppler flow EDF components using classification criteria. The system further comprises an image processing module 150, which is operated to form a 2D or 3D structural image from the received echographic signals RS and a motion image MI of the flowing fluid from the estimated Doppler flow component EDF provided by the signal processor 140. The images generated by the image processing module are displayed on an image display 160. The modules of the system of FIG. 8 are operated under control of a system controller 170, which is connected to a user control interface 180.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An ultrasound imaging method comprising the steps of:
forming a set of beams of ultrasound data signals in order to receive echographic signals RS with a small number EL of time samples from a region of interest comprising moving tissues and flowing fluids,
calculating Doppler signals X from said received echographic signals within said small number EL of time samples, said Doppler signals X comprising a Doppler clutter component corresponding to said moving tissues and a Doppler flow component corresponding to said flowing fluids,
separating said Doppler signals X into an orthonormal basis of a first estimated Doppler signal Z₁ and a second estimated Doppler signal Z₂,
calculating linear combinations of said first and second estimated Doppler signals which maximize a temporal coherence of said Doppler signals over said small number EL of time samples, 1, expressed by:
$$\hat{C} = \vert \frac{{\sum }_{l = 1}^{EL - 1} Z Z ( l ) Z {Z}^{*} ( l + 1 )}{\sqrt{{\sum }_{l = 1}^{EL - 1} Z Z ( l ) Z {Z}^{*} ( l ) {\sum }_{l = 2}^{EL} Z Z ( l ) Z {Z}^{*} ( l )}} \vert ,$$
deriving a third and a fourth estimated Doppler signals from first and second maxima of the coherence map,
classifying said third and a fourth estimated Doppler signals into an estimated Doppler clutter and an estimated Doppler flow components,
producing and displaying an image of the flowing fluids of said region of interest from said estimated Doppler flow component.

2. An ultrasound imaging system as claimed in claim 1, wherein said number of time samples comprises is at least equal to three.

3. An ultrasound imaging system as claimed in claim 1, wherein said step of calculating linear combinations comprises a substep of calculating a measure of separation of said first and second maxima.

4. An ultrasound imaging system as claimed in claim 1, wherein said classification step comprises a decision substep, which is intended to decide which from said third and fourth signals corresponds to the Doppler flow component using at least one decision criterion and a validation substep, which is intended to validate said decision using a validation measure.

5. An ultrasound imaging system as claimed in claim 4, wherein said decision criterion comprises an amplitude of said third and fourth signals.

6. An ultrasound imaging system as claimed in claim 4, wherein said decision criterion comprises a velocity of said third and fourth signals.

7. An ultrasound imaging system as claimed in claim 4, wherein said classification step comprises a substep of checking, in case only one maximum has been found, whether there is no remaining signal, by subtracting the maximum to the Doppler signal, in order to get a Doppler difference signal.

8. An ultrasound imaging system as claimed in claim 7, wherein said checking step is intended to compare an amplitude of said Doppler difference signal with a noise amplitude threshold.

9. An ultrasound imaging system as claimed in claim 4, wherein said validation substep is intended to use a decoherence value calculated from said Doppler signal at lag 1.

10. An ultrasound imaging system as claimed in one of claims 3 and 4, wherein said validation substep is intended to calculate a validation measure proportional to an amplitude of said third and fourth signals multiplied by said separation measure.

11. An ultrasound imaging system, comprising:
means for transmitting a set of beams of ultrasound signals to a region of interest comprising moving tissue and flowing fluid at a small number of time samples,
means for receiving echographic signals from said region of interest,
means for calculating Doppler signals X from said echographic signals, said Doppler signals X comprising a Doppler clutter component and a Doppler flow component, corresponding to said flowing fluid,
means for separating said Doppler signals X into an orthonormal basis of a first estimated Doppler signal and a second estimated Doppler signal,
means for calculating linear combinations of said first and second estimated Doppler signals which maximize a temporal coherence of said Doppler signals over said small number EL of time samples, 1, expressed by:
$$\hat{C} = \vert \frac{{\sum }_{l = 1}^{EL - 1} Z Z ( l ) Z {Z}^{*} ( l + 1 )}{\sqrt{{\sum }_{l = 1}^{EL - 1} Z Z ( l ) Z {Z}^{*} ( l ) {\sum }_{l = 2}^{EL} Z Z ( l ) Z {Z}^{*} ( l )}} \vert ,$$
means for deriving a third and a fourth estimated Doppler signals from first and second maxima,
means for classifying said first and second maxima into an estimated Doppler clutter and an estimated Doppler flow components,
means for producing and displaying an image of the flowing fluid of said region of interest from said estimated Doppler flow component.
